(19) United States
(12) Patent Application Publication
(10) Pub. No.: US 2005/0136387 A1
(43) Pub. Date: Jun. 23, 2005

(54) System and method for teaching

(76) Inventor: Erwin Karl Meimer, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/051,111

(22) Filed: Feb. 4, 2005

Related U.S. Application Data
(63) Continuation of application No. 09/921,061, filed on Aug. 1, 2001.
(60) Provisional application No. 60/223,438, filed on Aug. 4, 2000.

(51) Int. Cl. G09B 3/00; G09B 7/00

(52) U.S. Cl. 434/323

(57) ABSTRACT

A system and method for learning. In one embodiment, the system includes a teaching computer having a display module, a question and answer database, a testing module and a test question selection module. The question and answer database comprises a plurality of questions and corresponding answers to the questions, wherein the question and answer database stores information defining a plurality of learning levels for each of a plurality of questions. Each of the questions fall within one of the learning levels. The question and answer database also stores a retest time interval indicating a period of time that must pass between presentations of a selected question to a user. The testing module for providing a plurality of questions to a user and for recording answers to each of the questions. Each of the questions has an associated time interval indicating the duration of time that must pass before the question is presented again by the computer, wherein in response to receiving a correct answer to one of the questions, the teaching computer increases the time interval that is associated with the question. The test question selection module selects questions based in at least in part upon the learning levels and the retest time interval of the questions.

### RELATED APPLICATION

This application is a continuation of and incorporates by reference, in its entirety, U.S. application Ser. No. 09/921,061, filed Aug. 1, 2001, which in turn claims the benefit of U.S. Application No. 60/223,438, filed Aug. 4, 2000.

### BACKGROUND OF THE INVENTION

1. Field of the Invention

The invention relates to a systems and methods for teaching. More particularly, the invention relates a system and method for improving long term memory retention of a selected topic or subject matter.

2. Description of the Related Technology

The history of learning psychology stems from the German psychologist Dr. Hermann Ebbinghaus (1850-1909). He specifically investigated the question of memory retention of information. Generally speaking, most forgetting occurs immediately after learning new material. In a famous set of experiments, Hermann Ebbinghaus tested his own memory at various times after learning. Ebbinghaus wanted to be sure he would not be swayed by prior learning, so he memorized different series of nonsense syllables. See HERMANN EBBINGHAUS, MEMORY, A CONTRIBUTION TO EXPERIMENTAL PSYCHOLOGY (Über das Gedächtnis”) (Henry A. Ruger, et. al. trans., Dover Publications, Inc., 1964). The meaningless 3 letter words, e.g., “fap”, “jis”, and “mib”, were used to keep the learning experiments free of any correlation that could be made to previously attained knowledge. By waiting various lengths of time before testing himself, Ebbinghaus plotted the “Curve of Forgetting.” “Because of the great care Ebbinghaus took in his work, these findings remain valid today.” DENNIS COON, INTRODUCTION TO PSYCHOLOGY, EXPLORATION AND APPLICATION (West Publishing Company, 1980).

The following is an excerpt from the Ebbinghaus' book which was originally published in 1885. In this excerpt, Ebbinghaus relates his findings in the subsequent table, indicating values computed for the “Curve of Forgetting”:
“It will probably be claimed that the fact that forgetting would be very rapid at the beginning of the process and very slow at the end should have been foreseen . . . One hour after the end of the learning, the forgetting had already progressed so far that one half the amount of the original work had to be expended before the series could be reproduced again; after 8 hours the work to be made up amounted to two thirds of the first effort. Gradually however, the additional loss could be ascertained only with difficulty. After 24 hours about one third was always remembered; after 6 days about one fourth, and after a whole month fully one fifth of the first work persisted in effect. The decrease of this after-effect in the latter intervals of time is evidently so slow that it is easy to predict that complete vanishing of the affect of the first memorization of these series would, if they had been left to themselves, have occurred only after an indefinitely long period of time.”

HERMANN EBBINGHAUS MEMORY, A CONTRIBUTION TO EXPERIMENTAL PSYCHOLOGY at p. 76. Ebbinghaus relates his findings in the following table, indicating values computed for the Curve of Forgetting:

| Experiment | | | | |
|---|---|---|---|---|
| Number | Time elapsed | | Retained material | Amount forgotten |
| 1 | 0.33 | hr. | 58.2% | 41.8% |
| 2 | 1 | hr. | 44.2% | 55.8% |
| 3 | 8 | hrs. | 35.8% | 64.2% |
| 4 | 24 | hrs. | 33.7% | 66.3% |
| 5 | 48 | hrs. | 27.8% | 72.2% |
| 6 | 6 | days. | 25.4% | 74.6% |
| 7 | 31 | days. | 21.1% | 78.9% |

Id.

Thus it is seen that after a month of being presented material, almost 80% of all the material is forgotten. Thus, there is a need for a system and method of improving the long term memory retention of new information.

### SUMMARY OF THE INVENTION

One embodiment of the invention includes a testing system, comprising a testing module for presenting a user with a plurality of questions. Each of the plurality of questions has at least one associated answer and each of the plurality of questions is associated with one of a plurality of hierarchically ordered learning levels. In one embodiment, the lowest learning level contains questions that have not been previously presented to the user and the second to lowest learning level contains questions that have been previously missed by the user. The height of at least one learning levels in the hierarchical ordering is indicative of the user's knowledge of the answer to a question in the learning level relative to the knowledge of an answer to a question in at least one other learning level. The questions are presented based at least in part upon the ordering of the learning levels. In response to answering a question correctly, the testing module moves the selected question to a higher learning level. Conversely, in response to answering a question incorrectly, the question is moved into a lower learning level. Each question has an associated retest time interval. The retest time interval indicates a period of time that must be passed before the question is presented again. When the user answers a question correctly, the retest time interval is set for a period of time that is greater than the current retest time interval.

Another embodiment of the invention includes a testing system, comprising a display module for displaying a plurality of questions, a question and answer database comprising a plurality of questions and corresponding answers to the questions, and a testing module. The question and answer database stores information defining a plurality of learning levels for each of a plurality of questions, each of the questions falling within one of the learning levels. The question and answer database also stores a retest time interval indicating a period of time that must pass between presentations of a selected question to a user. The testing module provides a plurality of questions to a user and for recording answers to each of the questions. Each of the questions has an associated time interval indicating the duration of time that must pass before the question is presented again by the computer. In response to receiving a correct answer to one of the questions, the computer increases the time interval that is associated with the question.

### BRIEF DESCRIPTION OF THE DRAWINGS

FIG. 1 is a block diagram of one embodiment of a learning system that includes at least one teaching computer.

FIG. 2 is a block diagram of selected modules of the learning system of FIG. 1.

FIG. 3 is block diagram illustrating certain hierarchical levels that are associated with each of the questions in the learning system.

FIG. 4 is a flowchart illustrating one embodiment of a teaching and testing process of the learning system of FIG. 1.

FIG. 5 is a flowchart illustrating one embodiment of a process for selecting a question.

FIG. 6 is a screen display illustrating an exemplary report that is displayed by the teaching computer of FIG. 1.

FIG. 7 is a screen display illustrating another exemplary report that is displayed by the teaching computer of FIG. 1.

FIG. 8 is a screen display for printing a report that is maintained by the teaching computer of FIG. 1.

FIG. 9 is a screen display illustrating yet another exemplary report that is displayed by the teaching computer of FIG. 1.

FIG. 10 is screen display illustrating yet another exemplary report that is displayed by the teaching computer of FIG. 1.

FIG. 11 is screen display illustrating the study time of a user using the testing system.

FIG. 12 is a screen display illustrating accepted answers for a selected question.

FIG. 13 is a screen display containing information that is related to a selected question.

FIG. 14 is an exemplary report that is printed by the by the teaching computer of FIG. 1.

### DETAILED DESCRIPTION OF EMBODIMENTS OF THE INVENTION

The following detailed description is directed to certain specific embodiments of the invention. However, the invention can be embodied in a multitude of different ways as defined and covered by the claims.

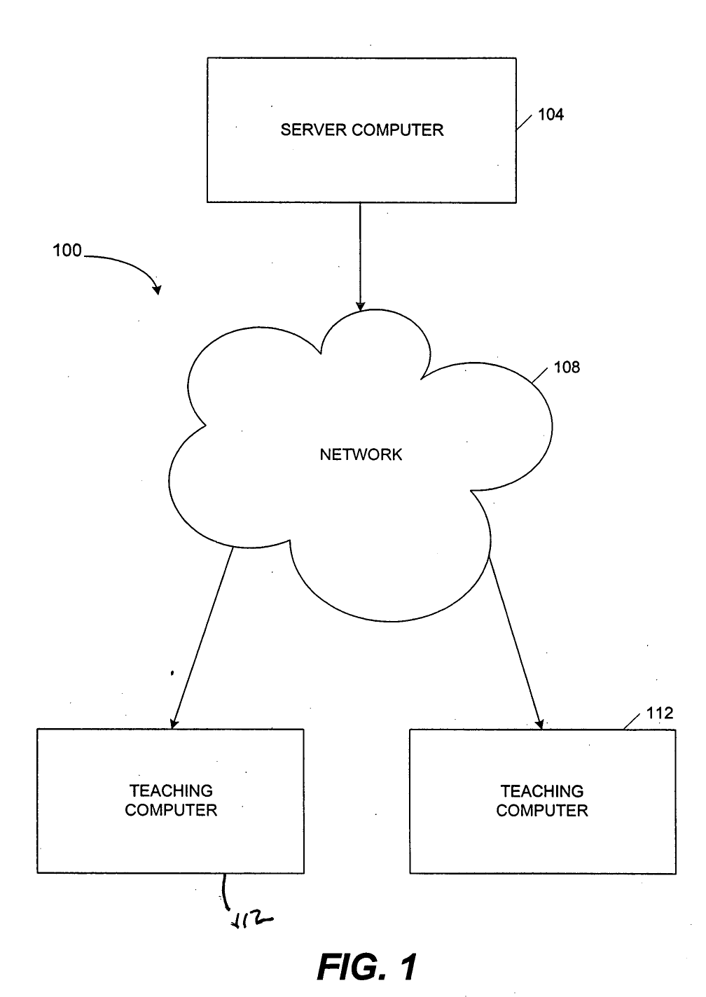

FIG. 1 is a block diagram illustrating one embodiment of a learning system 100. The learning system 100 includes a server computer 104, a network 108, and at least one teaching computer 112.

The teaching computer 112 presents questions regarding one or more selected topics to a user and records the user's answers. The questions may be true/false, multiple choice, or short answer. The topics may include business terms, medical terminology, foreign languages, as well as a myriad of subject areas which include a large number of vocabulary, definitions, and acronyms that should be mastered by heart. In one embodiment of the invention, the information that is to be learned for a selected topic is dissected into small, easily digestible questions. Several hundred questions typically make up one subject course of study. Each question often relates to a single piece of information that is to be learned.

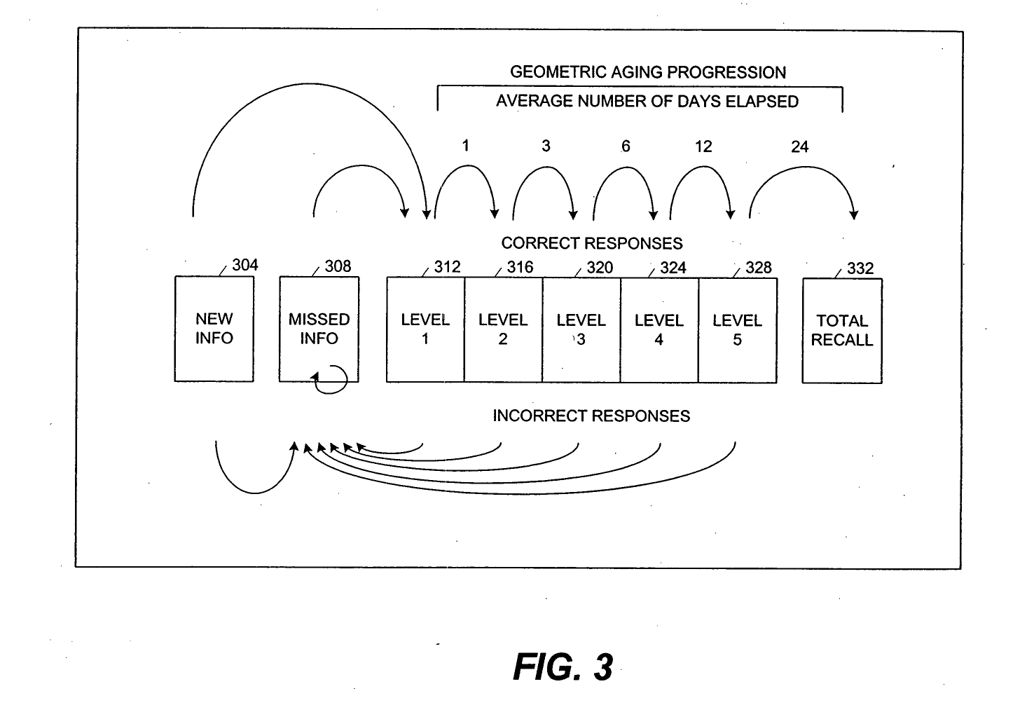

The questions can be stored on either the teaching computer 112 or the server computer 104. The teaching computer 112 records the user provided answers to the questions and, depending on the embodiment, either stores the results on the teaching computer 112 or transmits the results of the testing to the server computer 104. Embodiments of the teaching and testing process are described in further detail below with respect to FIGS. 3, 4, and 5.

As should be appreciated, the teaching computer 112 and the server computer 104 each include one or more input devices. For example, an input device may be a keyboard, rollerball, pen and stylus, mouse, or voice recognition system. The input device may also be a touch screen associated with an output device. The user may respond to prompts on the display by touching the screen. Textual or graphic information may be entered by the user through the input device.

The server computer 104 and the teaching computer 112 can each have one or more microprocessors. The microprocessor may be any conventional general purpose single- or multi-chip microprocessor such as a Pentium® processor, a Pentium® Pro processor, a 8051 processor, a MPS® processor, a Power PC® processor, or an ALPHA® processor. In addition, the microprocessor may be any conventional special purpose microprocessor such as a digital signal processor.

Furthermore, in one embodiment, the server computer 104 and the teaching computer 112 each operate under the control of a well-known operating system, such as UNIX, LINUX, Disk Operating System (DOS), OS/2, PalmOS, VxWorks, Windows 3.X, Windows 95, Windows 98, and Windows NT, and Windows CE.

The network 108 may include any type of electronically connected group of computers including, for instance, the following networks: Internet, Intranet, Local Area Networks (LAN) or Wide Area Networks (WAN). In addition, the connectivity to the network may be, for example, remote modem, Ethernet (IEEE 802.3), Token Ring (IEEE 802.5), Fiber Distributed Datalink Interface (FDDI) or Asynchronous Transfer Mode (ATM). Note that computing devices may be desktop, server, portable, hand-held, set-top, or any other desired type of configuration. As used herein, an Internet includes network variations such as public internet, a private internet, a secure internet, a private network, a public network, a value-added network, an intranet, and the like. The server computer 104 can include a number of computers that are in close or, alternatively, distant physical proximity and are linked via the network 108.

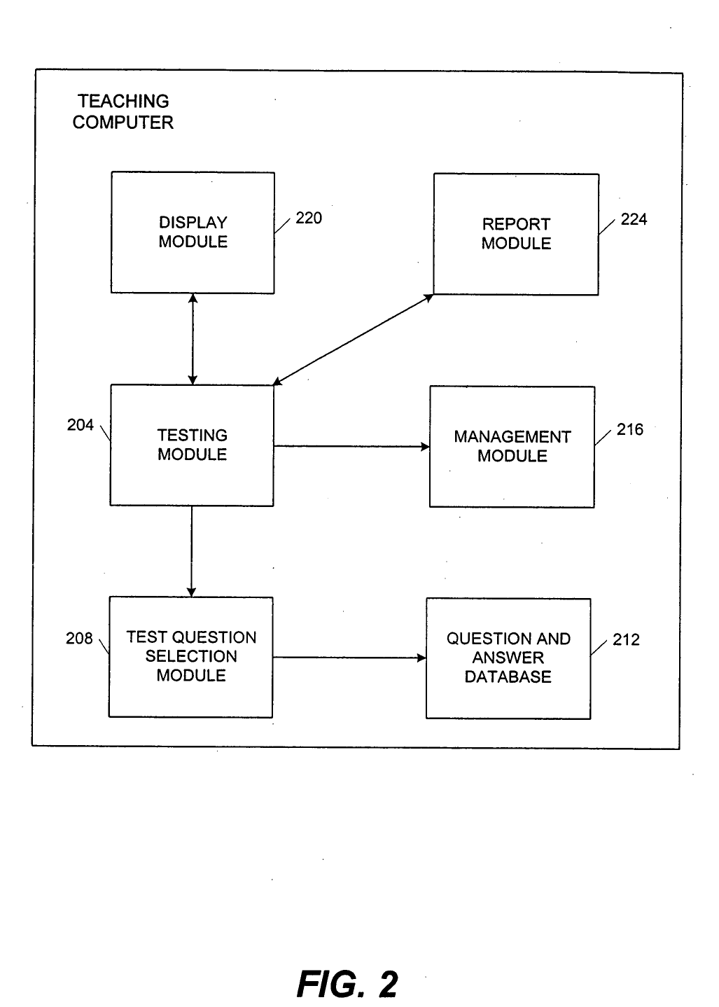

FIG. 2 is a block diagram illustrating selected modules of one embodiment the teaching computer 112. The teaching computer 112 includes a testing module 204, a test question selection module 208, a question and answer database 212, a display module 220, and a report module 224.

The testing module 204 controls the testing process and is in data communication with the test selection module 208, the management module 216, the display module 220, and the report module 224. The test selection module 208 is responsible for retrieving from a question and answer database 212 the next question for presentation to the user after a selected question is shown to the user. The question and answer database 212 stores each of the questions and acceptable answers to each of the questions. The display module 220 displays the questions on a display that is associated with the teaching computer 112 and receives answers that are provided by the users via the input devices that are associated with the teaching computer 112. The report module 224 generates predefined and/or ad-hoc reports regarding the testing process.

The management module 216 is used to send and receive information to and from the server computer 104. For example, new questions and answers can be periodically sent from the server computer 104 to the teaching computer 112. Furthermore, for example, the results of tests can be sent from the teaching computer 112 to the server computer 104.

The testing module 204, the test selection module 208, the question and answer database 212, the management module 216, the display module 220, and the report module 224, may each be written in any programming language such as C, C++, BASIC, Pascal, Java, and Fortran and run under the well-known operating system. C, C++, BASIC, Pascal, Java, and Fortran are industry standard programming languages for which many commercial compilers can be used to create executable code. Furthermore, in one embodiment of the invention, one or more of the modules are implemented in hardware.

As can be appreciated by one of ordinary skill in the art, each of the modules 204-224 comprise various sub-routines, procedures, definitional statements, and macros. Each of the modules 204-224 are typically separately compiled and linked into a single executable program. However, the processes that are undergone by each of the modules 204-224 may be arbitrarily redistributed to one of the other modules, combined together in a single module, or made available in a shareable dynamic link library. Furthermore, depending on the embodiment, the modules can be located completely or in part on the server computer 104, the teaching computer 112, or a combination thereof. In one embodiment of the invention, the modules are intended to operate as a standalone program on the teaching computer 112.

FIG. 3 is a block diagram illustrating certain hierarchical learning levels that are associated with each of the questions in the testing system 112. A learning level is logical concept that can be represented in a number of ways. For example, in one embodiment of the invention, a data structure is maintained that records for a selected question the name of the learning level and/or a level number of the learning level. The data structure may be maintained in the question and answer database 212. In another embodiment of the invention, each of the questions of a selected learning level are physically stored in a predefined location in a memory on the test computer 112 or on a disk drive. Each of the learning levels is either “higher” or “lower” than one of the other levels in the hierarchy. The terms higher and lower are used to describe the order of the levels in the hierarchy. In one embodiment of the invention and with respect to selected levels, if a first learning level is higher than a second learning level, then the questions in the first learning level are tested before the questions in the second learning level. Also, as will be discussed below, the height of learning levels can be representative of the number of times that a user answered the questions in the learning level correctly. The meaning of the ordering of the learning levels varies from embodiment to embodiment of the invention.

In one embodiment of the invention, the testing system 112 tests the user based at least in part upon the ordering of the levels in the learning level hierarchy. For example, in one embodiment of the invention, the learning system 112 starts presenting questions that are available in the highest learning levels and once all of the available questions in that learning level have been presented, the learning system 112 starts presenting questions in the next lower learning level in the learning level hierarchy and so on.

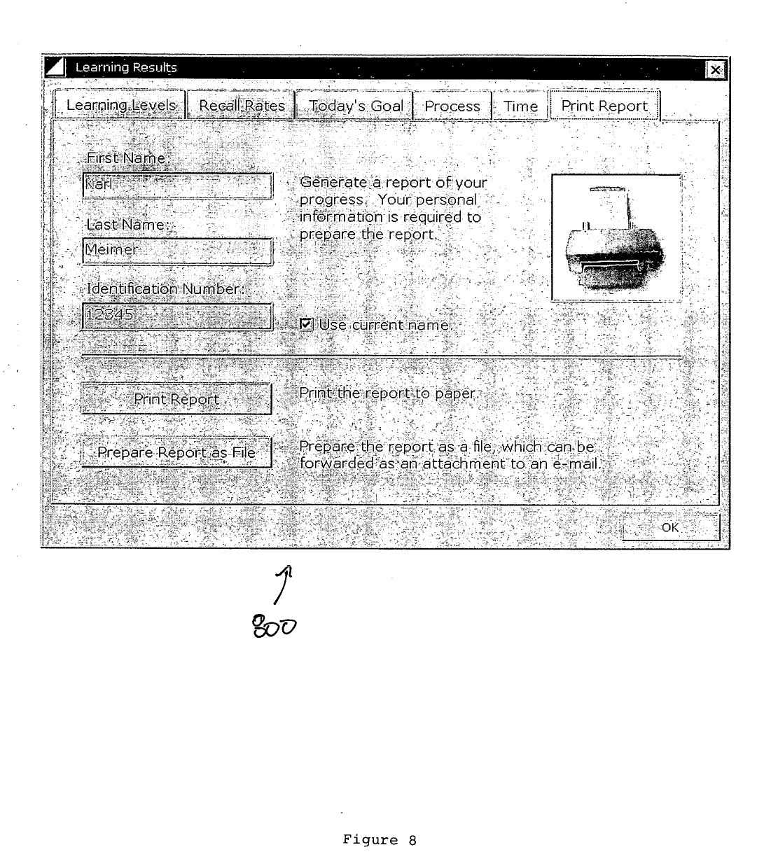

In the embodiment of the invention shown by FIG. 3, eight learning levels are illustrated. However, it is to be appreciated that, depending on the embodiment, the number and types of levels can be modified. As is shown in FIG. 8, the new information level 304, the lowest learning level, contains questions that are associated with new questions that have not yet been presented to a user. In one embodiment of the invention, the new information level 304 is the lowest of the learning level in the hierarchy of learning levels. The missed information level 308 contains questions that were missed by the user the last time that they were presented to the user. In one embodiment of the invention, the missed information level is the second to lowest learning level in the hierarchy of learning levels.

Learning levels 312, 316, 320, 324, 328, and 332, each include questions that have been answered by the user at least once. In one embodiment of the invention, the height of learning levels 312, 316, 320, 324, 328, and 332, is representative of the number of times that a user answered the questions in the learning level correctly. For example, the questions in learning level 312 (“Level 1”) were answered correctly once by the user the last time that they were presented. The questions in learning level 316 (“Level 2”) were answered correctly each of the last two times they were presented. The questions in learning level 320 (“Level 3”) were answered correctly each of the last three times they were presented. The questions in learning level 324 (“Level 4”) were answered correctly each of the last four times they were presented. The questions in learning level 328 (“Level 5”) were answered correctly each of the last five times they were presented. The questions in learning level 332 (“Total Recall”) were answered correctly each of the last six times they were presented.

In one embodiment of the invention, each of the levels has an associated retest time interval. For example, as is shown in FIG. 3, level 312 (“Level 1”) has a 1 day retest time interval. Thus, after a selected question is moved into level 312, the teaching computer 112 waits 1 day before further presenting the question. Further, for example, as is shown in FIG. 3, learning level 316 (“Level 2”) has a retest time interval of 2 days. After a question is moved into learning level 316, the teaching computer 112 waits 2 days before presenting further questions. In one embodiment of the invention, the testing system 112 increases the retest time interval by a non-linear function based upon the height of the learning level, e.g., an exponential function, a substantially exponential function, or a predetermined number of hours and/or days. In the embodiment of the invention shown in FIG. 3, the testing system does not present questions to the user that are associated with the learning level 332 (“Total Recall”), since it assumed that the user retained the answers to these questions in long term memory. In one embodiment of the invention, if learning sessions do not occur on subsequent days, each question still “ages” by the number of actual days passed since the last learning session. In another embodiment of the invention, each question “ages” only on days the user initiates a learning session.

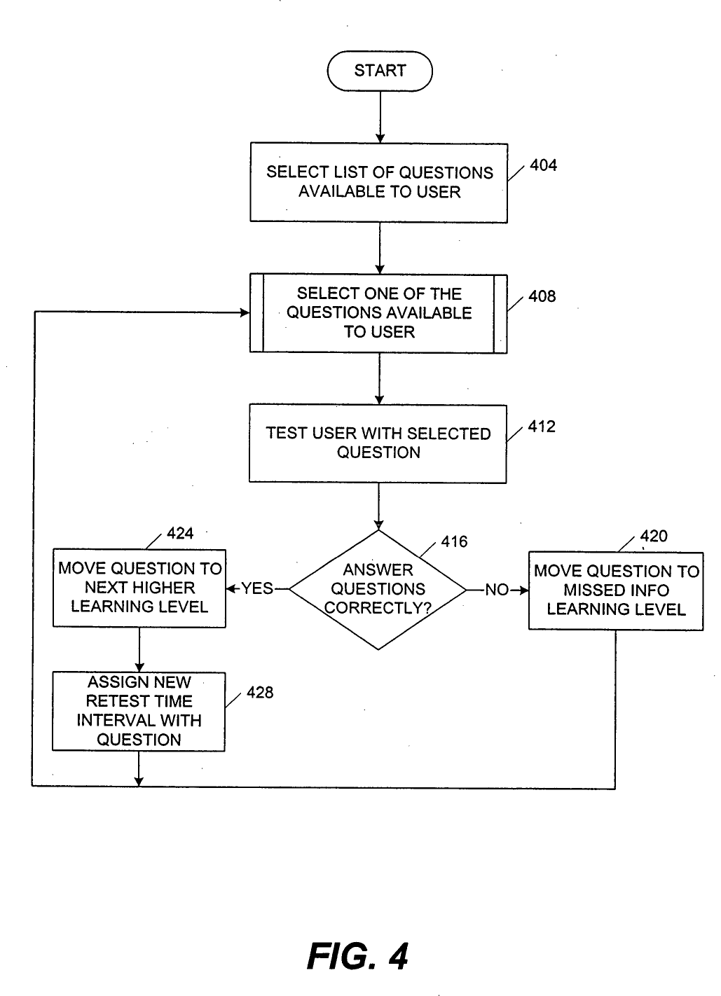

FIG. 4 is a flowchart illustrating one embodiment of a testing process that is performed by the teaching computer 112. Depending on the embodiment, additional steps may be added, others removed, and the ordering of the steps rearranged.

Starting at a step 404, a list of questions that are available for presentation to the user are selected. As was discussed above with respect to FIG. 3, the teaching computer 112 associates each question with a retest time interval. The retest time interval specifies a period of time that must pass before the question is presented after a prior presentation. If the time period has not passed, then the question is ineligible for presentation to the user.

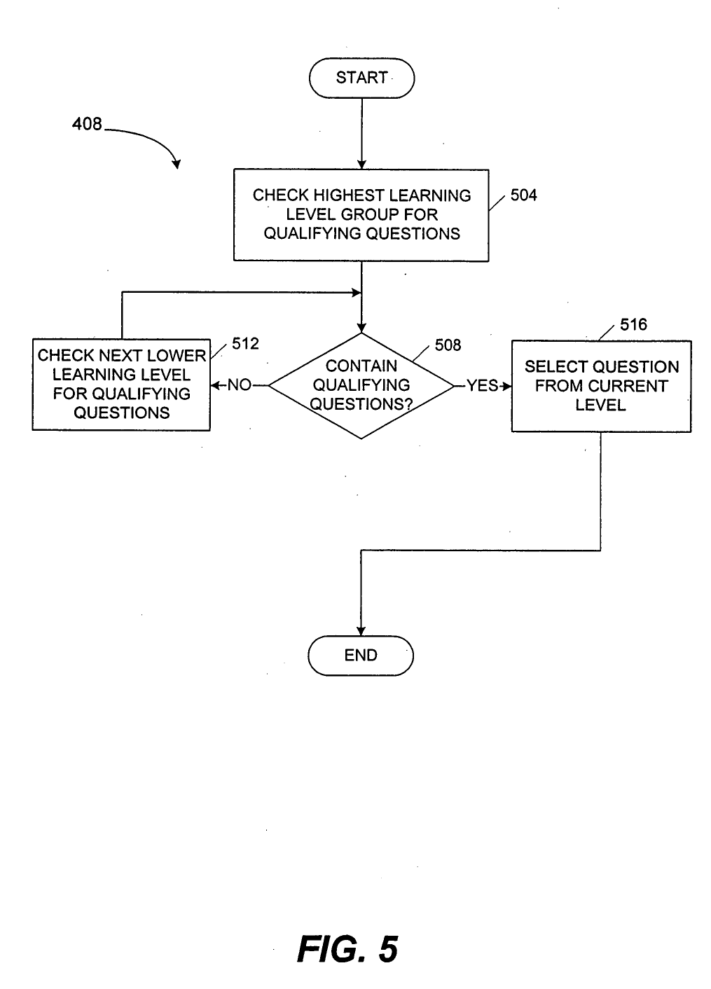

Continuing to a step 408, the teaching computer 112 selects one of the questions that are available to the user. The process of selecting a question is described in further detail below with respect to FIG. 5. Next, at a step 412, the testing system 112 displays and/or presents audibly to the user via speakers the selected question. The user types the answer via a keyboard, or verbally provides the answer to the teaching computer via voice recognition software.

Moving to a decision step 416, the teaching computer 112 determines whether the user answered the question correctly. It is noted that there may be more than one acceptable answer to a question. If the user answered the question incorrectly, the teaching computer 112 moves the question to a lower learning level. Furthermore, the correct response is presented to the user via the display and/or audibly.

In one embodiment of the invention, the teaching computer 112 moves the questions to the missed information group, i.e., learning level 312. This embodiment advantageously preserves the fact that the height of selected levels of a selected question is indicative of the number of times that the user answered the question correctly. In another embodiment of the invention, the teaching computer 112 decreases the height of the question in the learning level hierarchy by one level. For example, a question that was in learning level 320 (“Level 3”), would be moved to learning level 316 (“Level 2”). From the step 420, the teaching computer 112 returns to the step 408 to select another questions for testing.

Referring again to the decision step 416, if the testing system 112 determines that the user answered the question correctly, the testing system 112 proceeds to a step 424. At the step 424, the testing system 112 moves the question to the next higher learning level. For example, if the question was previously in learning level 320 (“Level 3”), the question would be move to learning level 324 (“Level 4”). Furthermore, if the user enters the correct response, the teaching computer 112 provides a reinforcing response, such as the red check mark appearing to the left of the correct answer. The user may also be shown an additional comment, explaining the answer in more detail and the answer may also be vocally transmitted via a speaker to further enhance the learning process. The user may repeat the audio answer by clicking on an audio icon.

Proceeding to a step 428, the teaching computer 112 assigns a new retest time interval to the correctly answered question. For example, as is shown in FIG. 3, questions falling within “Level 3” have a 6 day retest time interval. Assuming a question in learning level 320 (“Level 3”) was answered correctly, it would be moved to learning level 324 (“Level 4”) and the retest time interval would be set to 12 days. The teaching computer 112 would then return to the step 408 for further teaching and testing.

FIG. 5 is a flowchart illustrating a process of selecting a question for presentation to a user. FIG. 5 illustrates in further detail the steps that occur in step 408 of FIG. 4. Depending on the embodiment, selected steps may be added, others deleted, and the ordering of the steps may be rearranged.

Starting at a step 504, the testing computer 112 checks the highest learning level group for qualifying questions. For example, in the embodiment of the invention shown in FIG. 3, the teaching computer 112 starts presenting questions from learning level 328 (“Level 5”). Although the learning level 332 (“Total Recall”) could be logically defined as the highest learning level, in one embodiment of the invention the teaching computer 112 excludes from the testing process questions falling within this category since it is assumed that the user knows the answers to these questions.

Continuing to a decision step 508, the teaching computer 112 determines whether the currently selected level contains any qualifying questions. As discussed above, a learning level has a qualifying question if there are questions in the learning level and the retest time interval for one of the questions in the level has passed.

If the currently selected learning level does not have any qualifying questions, the teaching computer 112 proceeds to a step 512 and checks the next lower learning level for qualifying questions. The process then returns to the decision step 508 (discussed above).

Referring again to the decision step 508, if the currently selected level contains qualifying questions, the teaching computer 112 proceeds to a step 516. At the step 516, the teaching computer 112 selects one of the qualifying question from the current level. If there are no qualifying questions are found, the user is prompted to return the next day,

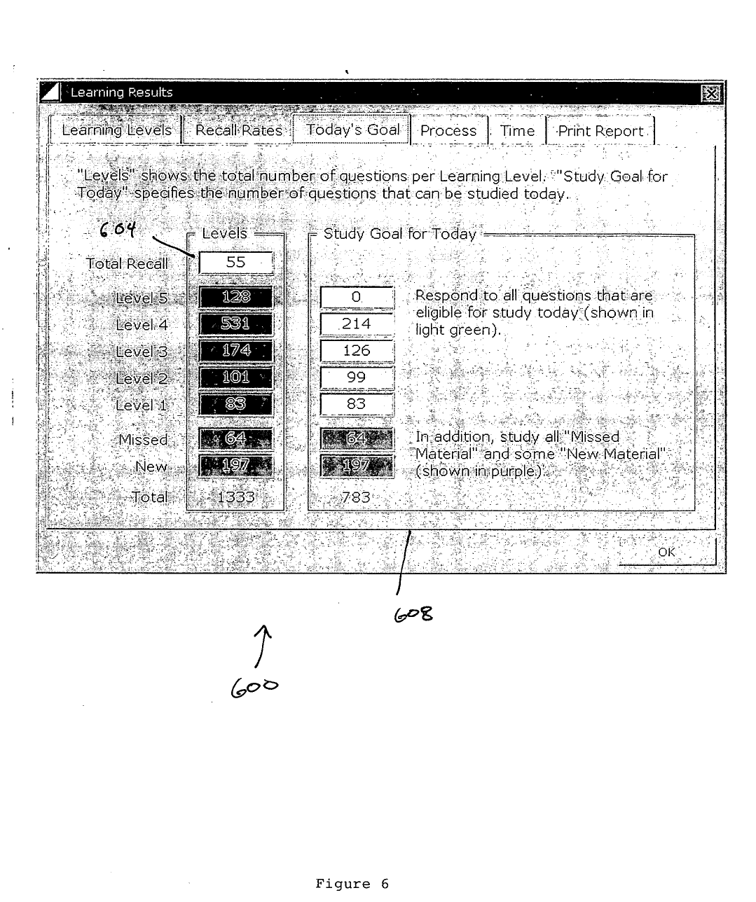

FIG. 6 is a screen display 600 illustrating an exemplary report that may be presented to the user upon the user's request. The report identifies the number of questions that are in each level for the user. As is shown in FIG. 6, a display field 604 indicates that the user has 55 questions in learning level 332 (“Total Recall”). Furthermore, the screen display 600 includes an eligibility window 608 identifying the number of questions that the user is eligible to study during that day.

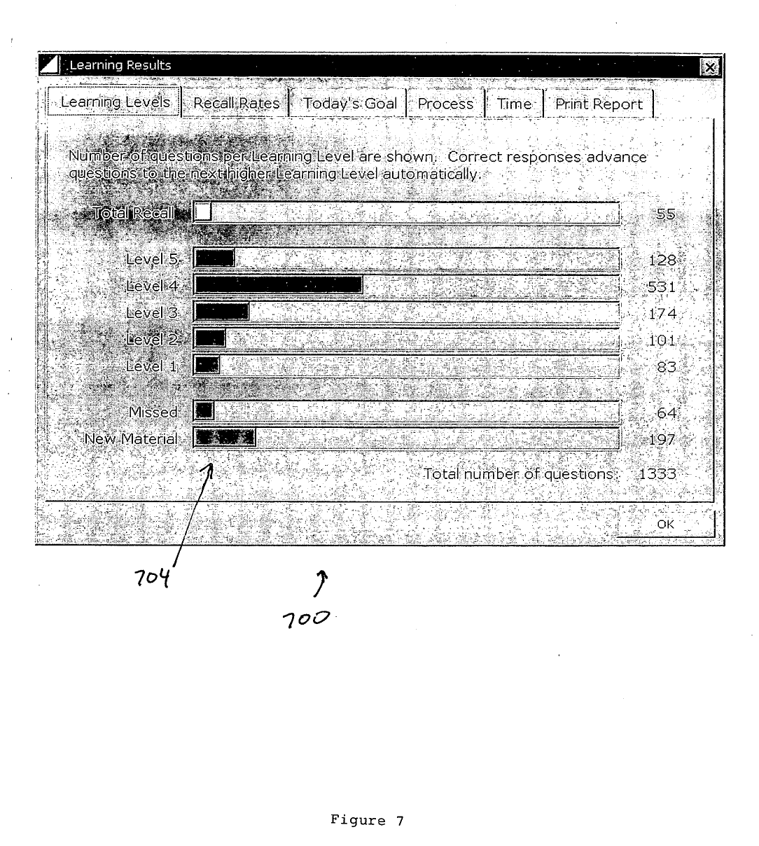

FIG. 7 is a screen display 700 illustrating another exemplary report that may be generated by the teaching computer 112. The screen display 700 includes a bar graph that graphically illustrates the number of questions that are within each of the learning levels.

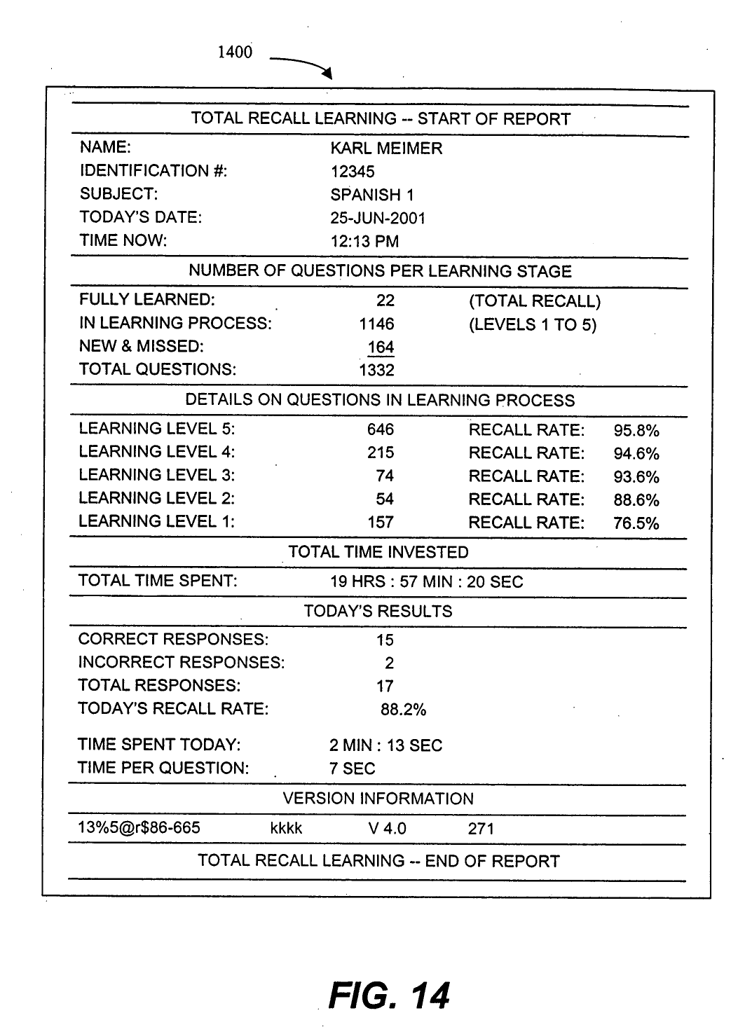

FIG. 8 is a screen display 800 that is used by the user for printing a status report. It is noted that in one embodiment, it is possible to print a report for a group or groups of users. FIG. 14 illustrates an exemplary report 144 that may be printed using the screen display 800.

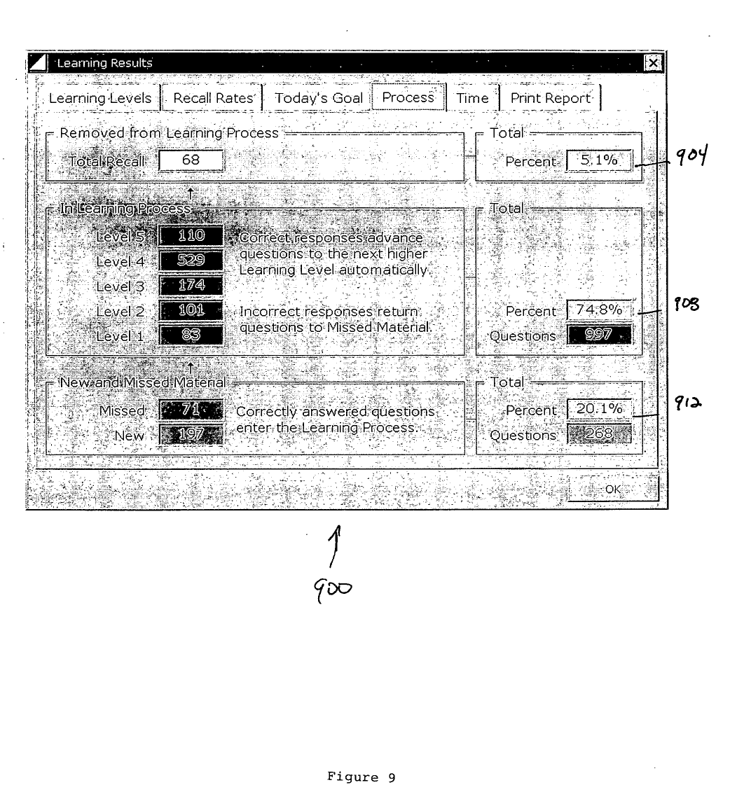

FIG. 9 is a screen display 900 illustrating an exemplary report that shows the percentage breakdown of questions falling within certain groups of learning levels. For example, as is shown in FIG. 9, the display field 904 indicates that 5.1% of the questions are in learning level 332 (“Total Recall”), the display field 908 indicates that 74.8% if the questions are in learning levels 308-328 (Learning Levels 1-5), display field 912 indicates that 20.1% of the questions are in learning levels 304 and 308 (“New Information” and “Missed Information” learning levels respectively).

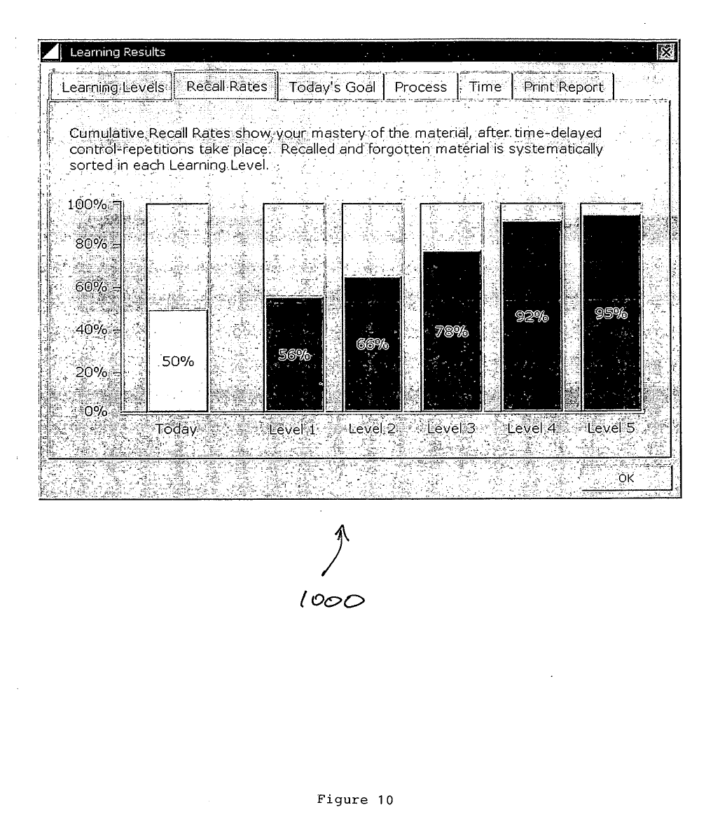

FIG. 10 is a screen display 1000 illustrating cumulative recall rates showing the mastery of the material. For example, as is shown in FIG. 10, the user has answered questions falling within learning level 328 (“Level 5”) 95% of the time.

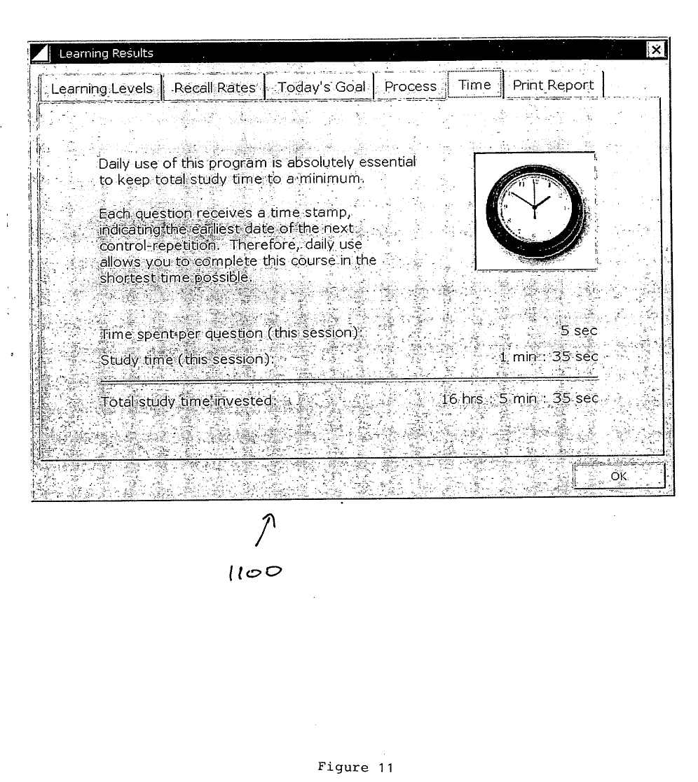

FIG. 11 is a screen display 1100 for providing the user test time information. The test time information indicates the time the user spent per question during a selected session and the total study time during the session.

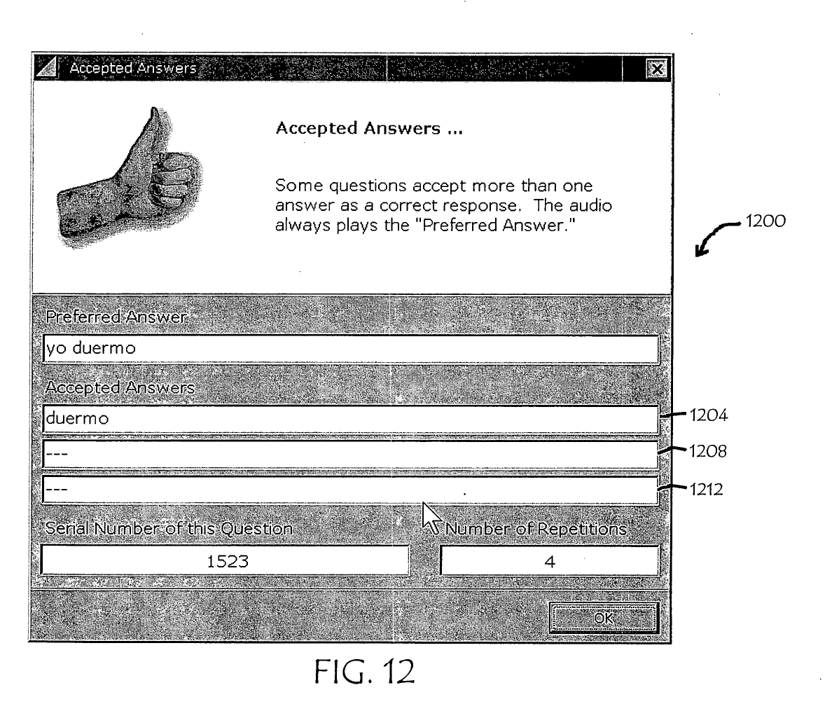

FIG. 12 is a screen display 1200 for displaying acceptable answers to a question. The screen display 1200 includes display fields 1204, 1208, and 1208, each storing a respective acceptable answer to a selected question.

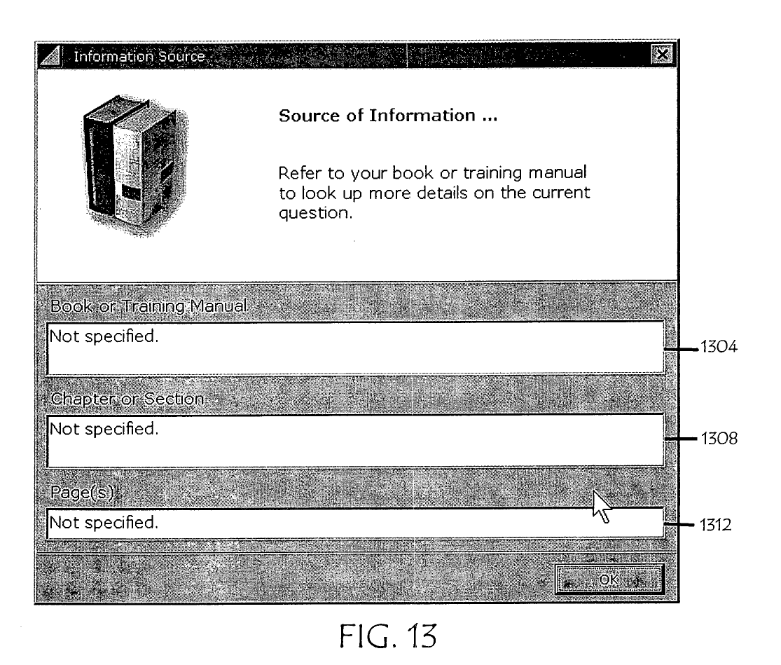

FIG. 13 is a screen display 1300 for displaying hyperlinks or references to reference material regarding a selected topic or question. The screen display 1300 includes a book or training manual field 1304, a chapter or section field 1308, and a pages field 1312. The book or training manual field 1304 contains hyperlinks or references to on-line books that relate to a selected question or topic. The chapter or section field identifies 1308 a particular page in the book or training manual that may be particularly relevant to a selected question or topic. The pages field 132 identifies a particular page that is relevant to a selected question or topic.

Description of an Exemplary Usage of the Teaching Computer

Set forth below is a description of the operation of an exemplary embodiment of the teaching computer 112. The following explanation assumes that the user uses the teaching computer 112 on a daily basis. While daily use is recommended to learn information in the shortest time possible, daily use is not essential to proper functionality.

### Day 1

When starting with the very first learning session, questions of a course are presented one by one. Once a new question is presented, the user either responds correctly or incorrectly. If answered correctly, the question is moved to the learning level 312 (“Level 1”). If answered incorrectly, the question is placed in the learning level 308 (“Missed Info”) for subsequent presentation to the user. In this embodiment, once the user has responded to a specific number of new questions, e.g., between 6 and 12, all incorrectly answered questions in the learning level 308 (“Missed Info”) is repeated over and over until answered correctly. It is noted that the number of new questions that are presented can vary depending on the embodiment. Correctly answered question are moved into learning level 312 (“Level 1”). Once all questions are removed from the level 308 (“Missed Info”), the process starts anew with a presentation of new questions.

The user may learn as many new questions as he desires at this time. If new questions remain in the learning level 304 (“New Info”), these questions can be accessed in any of the subsequent learning sessions. If more than one learning session takes place on day 1, the above sequence can be followed.

### Day 2

The teaching computer 112 starts presenting questions at the highest level in which questions reside. In the current example, some questions reside in learning level 312 (“Level 1”) from the learning session of day 1. Since questions in Level 1 qualify for repetition after one day, the teaching computer 112 presents questions in Level 1. In one embodiment, before presentation of the questions to the user, the questions in Level 1 are mixed to avoid the learning of information in sequence as well as to avoid any grouping of questions from a previous learning session. Correctly answered questions in Level 1 are then forwarded to learning level 316 (“Level 2”). Incorrectly answered questions are returned to the beginning of the learning process into the learning level 308 (“Missed Info”).

Once all qualifying questions in Level 1 have been presented to the user, the teaching computer 112 presents the information in the next lower level, which in this case is “Missed Info” learning level. The questions in the “Missed Info” learning level are repeated over and over until answered correctly. Correctly answered questions are moved from the “Missed Info” learning level to Level 1.

If the user chooses to continue with learning additional new questions, in case some questions remained in the “New Info” level, the user may do so at this time.

### Day 3

The sequence of information presented on day 3 follows the sequence of day 2. Questions currently in Level 2 have not “aged” sufficiently to be re-presented again, as the waiting period is three days. If the user chooses to continue with learning additional new questions, if any, the user may do so at this time.

### Day 4

The sequence of information presented on day 3 follows the sequence of day 2. Questions currently in Level 2 have not “aged” sufficiently to be re-presented again, as the waiting period is three days. If the user chooses to continue with learning additional new questions, if any, the user may do so at this time.

### Day 5

The teaching system 112 determines whether any questions in the highest learning level, in this example “Level 2” have “aged” sufficiently to qualify for presentation. At this time, questions which have been moved to Level 2 on day 2 qualify for presentation to the user. The questions in Level 2 are mixed before presentation to the user to avoid the learning of information in sequence and to avoid any grouping of questions from a previous learning session. Correctly answered questions in Level 2 are then forwarded to Level 3. In this embodiment, incorrectly answered questions are returned to the very beginning of the learning process into the “Missed Info” category.

Once all qualifying questions in Level 2 have been presented, the teaching system 112 turns to the questions in Level 1. The questions in Level 1 are mixed to avoid learning the material in sequence and to avoid any grouping of questions from a previous learning session. Once all questions in Level 1 have been presented to the user, the algorithm presents the information in the next lower level, i.e., learning level 308 (“Missed Info”). The questions in the “Missed Info” level are repeated over and over until answered correctly. The correctly answered questions are moved from the “Missed Info” learning level to Level 1. If the user chooses to continue with learning additional new questions, if any, the user may do so at this time.

### Day 6 and Onward

Following the above described process, questions are moved through the entire learning process (through all five retention levels) into learning level 332 (“Total Recall”). The entire learning process is therefore a “culling operation”, constantly culling user-known questions and answers into higher levels, and ultimately removing fully learned questions entirely from the learning process. As was recognized by Ebbinghaus with the Curve of Forgetting, information retained for several weeks remains almost indefinitely in the long-term memory of the user. Therefore, the testing computer 112 provides near total recall ability of the learned material.

The total time required to move a question into the “Total Recall” level depends on the user of the system. Since each user's questions are individually sorted to the user's responses, the time for completing an entire course varies. However, if a question is answered correctly each time it is presented throughout the several learning levels, the time to take that question to the level of “Total Recall” is 47 days, assuming that the day intervals between the retention levels are not adjusted for a specific course or application. It is to be appreciated that for other embodiment of the inventions, other time intervals will apply.

In order to keep the user apprised of the progress of the current and previous learning sessions, statistics are kept for informational purposes. These statistics can also be automatically forwarded to a management system to aid a training manager in evaluating the progress of the student. The testing computer 112 provides complete reports on the progress of the user. Not only do the statistics show how much work was invested learning the material, but the statistics show exactly how many questions are in the short, medium, and long-term memory of the user.

The teaching system 112 can be used to teach any topic or subject which can be dissected into small pieces of information. Some subject areas naturally lend themselves for this purpose, such as the following non-limiting examples: business terms, medical terminology, and foreign languages.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

1. A testing system, comprising:
a testing module for presenting a user with a plurality of questions,
wherein each of the plurality of questions has at least one associated answer,
wherein each of the plurality of questions is associated with one of a plurality of hierarchically ordered learning levels,
wherein the lowest learning level contains questions that have not been previously presented to the user,
wherein the second to lowest learning level contains questions that have been previously missed by the user,
wherein the height of at least one learning level in the hierarchical ordering is indicative of the user's knowledge of the answer to a question in the learning level relative to the knowledge of an answer to a question in at least one other learning level;
wherein the questions for a selected learning level are randomized prior to presentation;
wherein the questions are presented in sequence based at least in part upon the ordering of the learning levels,
wherein in response to answering a question correctly, the testing module moves the selected question to a higher learning level,
wherein in response to answering a question incorrectly, the question is moved into a lower learning level,
wherein each question has an associated retest time interval,
wherein the retest time interval indicates a period of time that must be passed before the question is presented again,
wherein when the user answers a question correctly, the retest time interval is set for a period of time that is greater than the current retest time interval, and
wherein if a respective question is moved into the highest learning level, the testing module ceases to ask the respective question.

2. A testing system, comprising:
a testing module for presenting a user with a plurality of questions, wherein each of the plurality of questions is classified into one of a plurality of hierarchically ordered levels;
wherein each of the plurality of questions has at least one associated answer,
wherein each of the plurality of questions is associated with one of the learning levels,
wherein the questions are presented in sequence based at least in part upon the ordering of the learning levels,
wherein in response to answering a question correctly, the testing module moves the selected question to a higher learning level in the hierarchical ordering,
wherein in response to answering a question incorrectly, the question is moved into a lower learning level,
wherein each question has an associated retest time interval,
wherein the retest time interval indicates a period of time that must be passed before the question is presented again,
wherein when the user answers a question correctly, the retest time interval is set for a period of time that is greater than the current retest time interval, and
wherein if a respective question is moved into a selected one of the learning levels, the testing module ceases to ask the respective question.

3. A method of testing, comprising:
selecting a set of questions to be made available to a user, wherein each of the questions has an associated learning level and a retest time interval that indicates a period of time that must pass between presentation of a respective question, and wherein the questions for a selected learning level are randomized prior to presentation;
selecting one of the available questions from the set;
testing the user with the selected question;
determining whether the user answered the selected question correctly;
if the user answered the selected question correctly, increasing the retest time interval to be greater than the current retest time interval for the selected question; and
if the user answered the selected question incorrectly, decreasing the retest time interval to be less than the current retest time interval for the selected question.

4. The method of claim 5, additionally comprising, if a user answers a question incorrectly, moving the question into a level designated for missed questions.

5. The method of claim 6, wherein the level designated for missed questions is the lowest learning level of the learning levels.

6. The method of claim 6, wherein the level designated for missed questions is the second lowest learning level.

7. The method of claim 6, wherein the lowest level contains questions that have not been previously presented to the user.

8. The method of claim 5, additionally comprising, if a user answers a selected question incorrectly, moving the selected question into the next lowest learning level.

9. The method of claim 5, additionally comprising, if a user answers a selected question incorrectly, maintaining the selected question at the selected learning level until the question is answered correctly.

10. The method of claim 5, additionally comprising, if a question is answered incorrectly, setting the retest time interval such that the user is presented the question as soon as the testing module presents questions in the learning level of the selected question.

11. The method of claim 5, wherein the questions are presented in sequence based at least in part upon the ordering of the learning levels.
